(19) United States
(12) Patent Application Publication
(10) Pub. No.: US 2026/0018003 A1
(43) Pub. Date: Jan. 15, 2026

(54) IMAGE CAPTURING APPARATUS, IMAGE CAPTURING METHOD, AND RECORDING MEDIUM

(71) Applicant: NEC Corporation, Minato-ku, Tokyo (JP)

(72) Inventor: Kosuke YOSHIMI, Tokyo (JP)

(73) Assignee: NEC Corporation, Minato-ku, Tokyo (JP)

(21) Appl. No.: 18/994,665

(22) PCT Filed: Aug. 16, 2022
(86) PCT No.: PCT/JP2022/030982

§ 371 Date: Jan. 15, 2025

(51) Int. Cl. G07C 9/37; H04N 23/55; H04N 23/56; H04N 23/695

(52) U.S. Cl. CPC G07C 9/37; H04N 23/55; H04N 23/56; H04N 23/695

(57) ABSTRACT

An image capturing apparatus according to the present disclosure includes: an image capturing unit that captures an image of a target; a rotating mirror that rotates about a first rotation shaft and is capable of changing an image capturing direction of the image capturing unit; and a control unit that controls the image capturing unit to capture an image of the target moving in a first direction in a first lane after causing the rotating mirror to rotate to a first angle and controls the image capturing unit to capture an image of the target moving in a second direction in a second lane after causing the rotating mirror to rotate to a second angle, the second direction being different from the first direction.

### TECHNICAL FIELD

The present disclosure relates to an image capturing apparatus, an image capturing method, and a recording medium.

### BACKGROUND ART

PTL 1 describes a gate system that executes biometric identification on a target using a biometric image of the target, thereby managing entry to and exit from a managed area.

### CITATION LIST

### Patent Literature

PTL 1: Japanese Patent Application Laid-Open No. 2005-242775

### SUMMARY OF INVENTION

### Technical Problem

An example object of the present disclosure is to improve the technique described in PTL 1.

### Solution to Problem

According to an example aspect of the present disclosure, there is provided an image capturing apparatus including: an image capturing unit that captures an image of a target; a rotating mirror that rotates about a first rotation axis and is capable of changing an image capturing direction of the image capturing unit; and a control unit that controls the image capturing unit to capture an image of the target moving in a first direction in a first lane after causing the rotating mirror to rotate to a first angle and controls the image capturing unit to capture an image of the target moving in a second direction in a second lane after causing the rotating mirror to rotate to a second angle, the second direction being different from the first direction.

According to another example aspect of the present disclosure, there is provided an image capturing method including: causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and causing the image capturing apparatus to capture an image of the target moving in a second direction in a second lane after causing the rotating mirror to rotate to a second angle, the second direction being different from the first direction.

According to another example aspect of the present disclosure, there is provided a recording medium in which a program is recorded, the program causing a computer to execute: causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and causing the image capturing apparatus to capture an image of the target moving in a second direction in a second lane after causing the rotating mirror to rotate to a second angle, the second direction being different from the first direction.

### BRIEF DESCRIPTION OF DRAWINGS

FIG. 1 is a block diagram illustrating an example of the general configuration of an authentication system according to a first example embodiment.

FIG. 2 is a block diagram illustrating an example of a hardware configuration of an authentication apparatus according to the first example embodiment.

FIG. 3 is a front view of the authentication apparatus according to the first example embodiment.

FIG. 4 is a rear view of the authentication apparatus according to the first example embodiment.

FIG. 5 is a top view for describing the general configuration of the authentication system according to the first example embodiment.

FIG. 6 is a schematic diagram for describing the internal structure of the authentication apparatus according to the first example embodiment.

FIG. 7 is a schematic diagram for describing the internal structure of the authentication apparatus according to the first example embodiment.

FIG. 8 is a schematic diagram for describing the internal structure of the authentication apparatus according to the first example embodiment.

FIG. 9 is a schematic diagram for describing the internal structure of the authentication apparatus according to the first example embodiment.

FIG. 10 is a flowchart illustrating an outline of processing executed by the authentication apparatus according to the first example embodiment.

FIG. 11 is a flowchart illustrating an outline of processing executed by the authentication apparatus according to the first example embodiment.

FIG. 12 is a flowchart illustrating an outline of processing executed by the authentication apparatus according to the first example embodiment.

FIG. 13 is a top view for describing the general configuration of an authentication system according to a second example embodiment.

FIG. 14 is a front view for describing the general configuration of the authentication system according to the second example embodiment.

FIG. 15 is a block diagram illustrating an example of a hardware configuration of an authentication apparatus according to a third example embodiment.

FIG. 16 is a top view for describing the general configuration of an authentication system according to the third example embodiment.

FIG. 17 is a top view for describing the general configuration of the authentication system according to the third example embodiment.

FIG. 18 is a flowchart illustrating an outline of processing executed by the authentication apparatus according to the third example embodiment.

FIG. 19 is a schematic diagram for describing a linkage structure of a rotating mirror and an illuminating apparatus according to a fourth example embodiment. FIG. 20 is a schematic diagram for describing the linkage structure of the rotating mirror and the illuminating apparatus according to the fourth example embodiment.

FIG. 21 is a flowchart illustrating an outline of processing executed by an authentication apparatus according to a fifth example embodiment.

FIG. 22 is a flowchart illustrating an outline of processing executed by an authentication apparatus according to a sixth example embodiment.

FIG. 23 is a block diagram illustrating an example of a hardware configuration of an authentication apparatus according to a seventh example embodiment.

FIG. 24 is a schematic diagram for describing the internal structure of the authentication apparatus according to the seventh example embodiment.

FIG. 25 is a functional block diagram illustrating the general configuration of an image capturing apparatus according to an eighth example embodiment.

### DESCRIPTION OF EMBODIMENTS

Example embodiments of the present disclosure will be described below with reference to the drawings. In the drawings, similar or corresponding elements are denoted by the same reference characters, and the description thereof may be omitted or simplified.

### First Example Embodiment

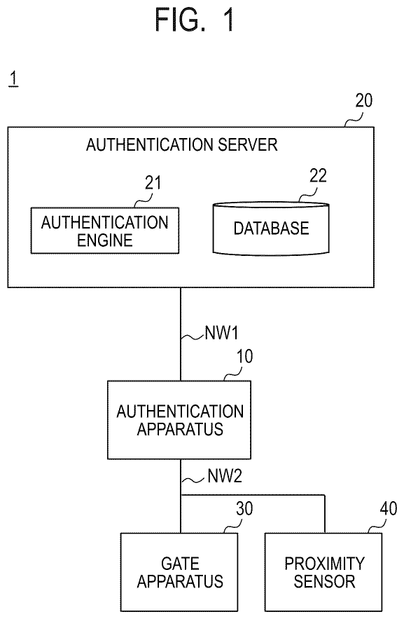

FIG. 1 is a block diagram illustrating an example of the general configuration of an authentication system 1 according to a first example embodiment. The authentication system 1 includes an authentication apparatus 10, an authentication server 20, a gate apparatus 30, and proximity sensors 40. The apparatuses are connected to networks NW1 and NW2 such as a local area network (LAN) and the Internet.

The authentication system 1 is a walk-through biometric identification system that performs biometric identification by obtaining biometric information on a target who is moving in a lane in which an authentication zone is set and checking the obtained biometric information against registered biometric information items that are registered in advance in a database 22.

The term “biometric information” in the first example embodiment is to mean an iris image and feature quantities extracted from the iris image. However, the biometric information is not limited to the iris image and the feature quantities. That is, the authentication system 1 may use, as the biometric information on the target, a biometric image other than an iris image (a face image, a fingerprint image, a palmprint image, an auricle image, etc.) and feature quantities for the biometric identification.

The authentication system 1 is applicable to, for example, personal identification for departure and immigration in an airport, personal identification in an administrative agency, personal identification for entry and exit in a factory/office, personal identification for entry and exit in an event venue, and the like.

The authentication apparatus 10 is an image capturing apparatus for biometric identification that captures the image of an iris of a target to be authenticated who is present in the authentication zone and outputs the iris image to the authentication server 20. In the first example embodiment, “authentication zone” means a three-dimensional space within a predetermined range that is set in each of a first lane and a second lane described later.

The authentication server 20 is a computer that executes the biometric identification. The authentication server 20 includes an authentication engine 21 and the database 22. The authentication engine 21 executes check processing on the iris image (or its feature quantities) of the target captured by the authentication apparatus 10 and registered iris images (or their sets of feature quantities) of registered persons who are registered in advance in the database 22. On the basis of the result of the check processing, the authentication engine 21 performs iris authentication on the target. The database 22 is a storage apparatus that stores a registered iris image of and attribute information on a registered person who is to be permitted to pass through the gate apparatus 30, in association with a registered person ID. Note that the database may further store biometric information other than iris images.

The gate apparatus 30 is a passage control apparatus that controls the passage of the target by opening and closing a gate on the basis of control information from the authentication apparatus 10. The system of the gate is not limited to a particular system. Examples of the gate include a flap barrier gate that opens and closes a flapper or flappers provided on one side or both sides of a lane and a turnstile gate that rotates a tripod.

The proximity sensors 40 are devices that detect an approaching target in a contactless manner. Note that the sensors for detecting a target are not limited to the proximity sensors 40. Examples of the sensor include a pressure-sensitive sensor, a photo microsensor, a photoelectric sensor, and a contact detection sensor.

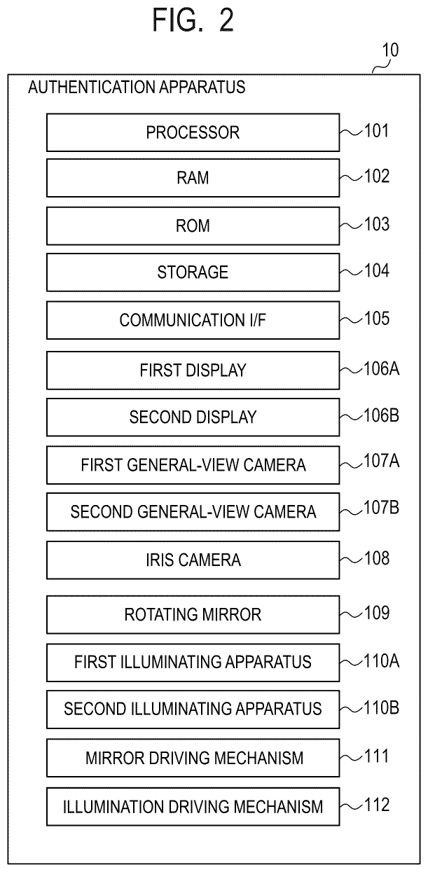

FIG. 2 is a block diagram illustrating an example of a hardware configuration of the authentication apparatus 10 according to the first example embodiment. As a computer that performs computation, control, and storage, the authentication apparatus 10 includes a processor 101, a random access memory (RAM) 102, a read only memory (ROM) 103, a storage 104 a communication interface (I/F) 105, a first display 106A, a second display 106B, a first general-view camera 107A, a second general-view camera 107B, an iris camera 108, a rotating mirror 109, a first illuminating apparatus 110A, a second illuminating apparatus 110B, a mirror driving mechanism 111, and an illumination driving mechanism 112. The apparatuses are connected together via a bus, wiring, a driving apparatus, and the like, which are not illustrated.

The processor 101 has a function of performing predetermined computation under a program stored in the ROM 103, the storage 104, or the like to control the units of the authentication apparatus 10. As the processor 101, a central processing unit (CPU), a graphics processing unit (GPU), a field programmable gate array (FPGA), a digital signal processor (DSP), an application specific integrated circuit (ASIC), or the like is used. One of the above-mentioned examples may be used, or more than one of the examples described above may be used in a parallel configuration.

The RAM 102 includes a volatile storage medium. The RAM 102 provides a temporary memory region necessary for the operation of the processor 101. The RAM 102 may be, for example, a dynamic RAM (D-RAM). The ROM 103 includes a nonvolatile storage medium. The ROM 103 stores information necessary for the operation of the authentication apparatus 10, such as a program. The ROM 103 may be, for example, a programmable ROM (P-ROM).

The storage 104 includes a nonvolatile storage medium. The storage 104 performs the storage of data, the storage of a program for the operation of the authentication apparatus 10, and the like. The storage 104 includes, for example, a hard disk drive (HDD) or a solid state drive (SSD).

The communication I/F 105 is a communication interface based on a standard such as Ethernet (R), Wi-Fi (R), 4G, or 5G. The communication I/F 105 is a module for communication with another apparatus.

The processor 101 loads a program stored in the ROM 103, the storage 104, or the like onto the RAM 102 and executes the program.

The first display 106A and the second display 106B are each a display apparatus that displays a video, a still image, characters, and the like. The first display 106A is provided on a first surface (front surface) side in a housing of the authentication apparatus 10. In contrast, the second display 106B is provided on a second surface (back surface) side that faces the first surface in the same housing. The first display 106A and the second display 106B have the same functions and differ only in their installation positions in the housing of the authentication apparatus 10. Hereinafter, in the case where the first display 106A and the second display 106B are not distinguished from each other, the first display 106A and the second display 106B are collectively referred to as displays 106. As the displays 106, a liquid crystal display, an organic light emitting diode (OLED) display, or the like is used.

The first general-view camera 107A and the second general-view camera 107B are each an image capturing apparatus that captures a whole image of a surrounding region of the authentication apparatus 10. The first general-view camera 107A is provided on the first surface (front surface) side of the housing. In contrast, the second general-view camera 107B is provided on the second surface (back surface) side in the same housing. The first general-view camera 107A and the second general-view camera 107B have the same functions and differ only in their installation positions in the housing of the authentication apparatus 10. Hereinafter, in the case where the first general-view camera 107A and the second general-view camera 107B are not distinguished from each other, the first general-view camera 107A and the second general-view camera 107B are collectively referred to as general-view cameras 107.

The general-view cameras 107 each include a light receiving element configured to have sensitivity to visible light. As the general-view cameras 107, digital cameras with a complementary metal oxide semiconductor (CMOS) image sensor, a charge coupled device (CCD) image sensor, or the like are used such that the general-view cameras 107 are suitable for image processing by the authentication apparatus 10. The general-view cameras 107 are capable of capturing a face image of a target including an iris of the target, an image of a whole body of the target including the iris, and the like.

The iris camera 108 is an image capturing apparatus that captures an image of a predetermined body part of a target. The predetermined body part includes an iris. The iris camera 108 includes a light receiving element configured to have sensitivity to infrared light. As the iris camera 108, a digital camera with a CMOS image sensor, a CCD image sensor, or the like is used.

The rotating mirror 109 is a member that is provided rotatably about a rotation axis and changes an image capturing direction of an image capturing unit (the iris camera 108). The rotating mirror 109 of the first example embodiment rotates about a rotation axis extending in a horizontal direction.

The first illuminating apparatuses 110A and the second illuminating apparatuses 110B each include a light emitting element that emits infrared light, such as an infrared LED. The first illuminating apparatuses 110A are provided on the first surface (front surface) side of the housing. In contrast, the second illuminating apparatuses 110B are provided on the second surface (back surface) side in the same housing. The first illuminating apparatuses 110A and the second illuminating apparatuses 110B have the same functions and differ only in their installation positions in the housing of the authentication apparatus 10. Hereinafter, in the case where the first illuminating apparatuses 110A and the second illuminating apparatuses 110B are not distinguished from each other, the first illuminating apparatuses 110A and the second illuminating apparatuses 110B are collectively referred to as illuminating apparatuses 110. The wavelength of the infrared light applied by the illuminating apparatuses 110 can be in, for example, a near infrared region about 800 nm. The timing at which the illuminating apparatuses 110 apply illumination light is in synchronization with the timing at which the iris camera 108 captures the image. Note that the timing at which the illuminating apparatuses 110 apply the illumination light may be out of synchronization with the timing at which the iris camera 108 captures the image.

The mirror driving mechanism 111 is a driving apparatus that drives the rotating mirror 109 connected to a rotation axis (not illustrated). In the first example embodiment, the rotating mirror 109 is assumed to be directly connected to the rotation axis of the mirror driving mechanism 111. Note that the rotating mirror 109 may be indirectly connected to the rotation axis of the mirror driving mechanism 111 via, for example, a gear or a belt, or the like.

The illumination driving mechanism 112 is a driving apparatus that drives the illuminating apparatuses 110 connected to a rotation axis (not illustrated). In the first example embodiment, the illuminating apparatuses 110 are assumed to be directly connected to the rotation axis of the illumination driving mechanism 112. Note that the illuminating apparatuses 110 may be indirectly connected to the rotation axis of the illumination driving mechanism 112 via, for example, a gear or a belt, or the like.

Note that the hardware configuration illustrated in FIG. 2 is an example. An apparatus other than these apparatuses may be added, or some of the apparatuses need not be provided. Alternatively, some of the apparatuses may be replaced with another apparatus or other apparatuses having the same functions. Alternatively, some of the functions of the first example embodiment may be provided by another apparatus over a network, or the functions of the first example embodiment may be implemented by a plurality of distributed apparatuses. The hardware configuration illustrated in the figure can be modified as appropriate.

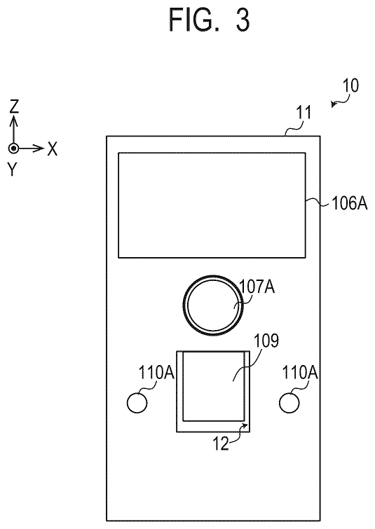

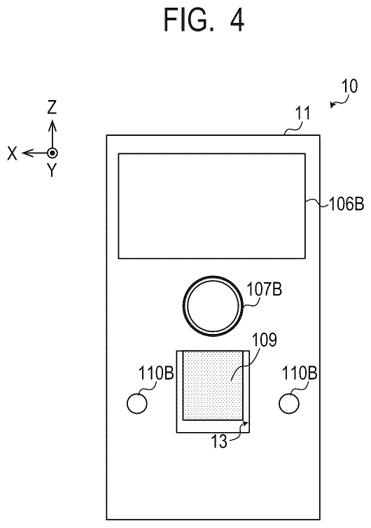

FIG. 3 and FIG. 4 are a front view and a rear view of the authentication apparatus 10 according to the first example embodiment, respectively. With reference to FIG. 3 and FIG. 4, the positional relationship among constituent elements constituting the authentication apparatus 10 will using be described, a three-dimensional coordinate system constituted by an X-axis, a Y-axis, and a Z-axis that are perpendicular to one another. The X-axis and the Y-axis are axes in a horizontal plane. The X-axis, the Y-axis, and the Z-axis are perpendicular to one another. The Z-axis is an axis perpendicular to the horizontal plane. Note that a first opening 12 and a second opening 13 that are formed in a front surface and a rear surface of a housing 11 of the authentication apparatus 10 are covered with a filter or the like, which is omitted in FIG. 3 and FIG. 4.

In FIG. 3, the first display 106A, the first general-view camera 107A, and the rotating mirror 109 are disposed in this order from top to bottom along a center line of the authentication apparatus 10. The rotating mirror 109 is provided inside the housing 11 of the authentication apparatus 10, and the mirror surface of the rotating mirror 109 is visible through the first opening 12. On both sides of the first opening 12, a pair of first illuminating apparatuses 110A are disposed.

In contrast, in FIG. 4, the second display 106B, the second general-view camera 107B, and the rotating mirror 109 are disposed in this order from top to bottom along the center line of the authentication apparatus 10. The back surface of the rotating mirror 109 is visible through the second opening 13. On both sides of the second opening 13, a pair of second illuminating apparatuses 110B are disposed.

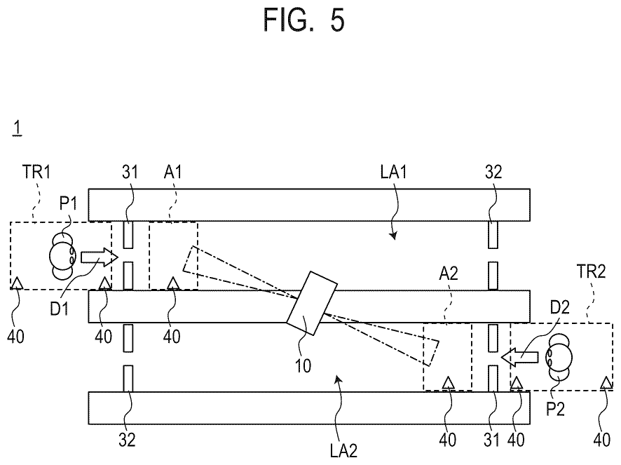

FIG. 5 is a top view for describing the general configuration of the authentication system 1 according to the first example embodiment. In FIG. 5, the authentication apparatus 10 is located between a first lane LA1 and a second lane LA2. Regions enclosed by chain lines indicate image capturing directions and image capturing ranges of the authentication apparatus 10. That is, two types of image capturing directions of the authentication apparatus 10 intersect directions in which the first lane LA1 and the second lane LA2 extend. This enables the authentication apparatus 10 to capture images of targets who are moving through the first lane LA1 and the second lane LA2 in oblique directions.

A target P1 is present in a first trigger zone TR1 provided in front of the entrance of the first lane LA1. The target P1 moves in a first direction D1 after a first gate 31 in front of the target P1 is opened. The first trigger zone TR1 is a zone for detecting the target P1 moving toward the first lane LA1. On the entrance side and the exit side of the first lane LA1, the first gate 31 and a second gate 32 of the gate apparatus 30 are provided, respectively. Between the first gate 31 and the second gate 32 and in the vicinity of the first gate 31, there is provided a first authentication zone A1 where the authentication of the target P1 is performed. When the first gate 31 of the first lane LA1 is opened, the target P1 moves from the first trigger zone TRI to the first authentication zone A1. Thus, the authentication apparatus 10 switches between the image capturing directions of the iris camera 108 to capture an image of the target P1 and captures an image of an iris of the target P1.

Likewise, a target P2 is present in a second trigger zone TR2 provided in front of the entrance of the second lane LA2. The target P2 moves in a second direction D2 after a first gate 31 in front of the target P2 is opened. The second trigger zone TR2 is a zone for detecting the target P2 moving toward the second lane LA2. On the entrance side and the exit side of the second lane LA2, the first gate 31 and a second gate 32 of the gate apparatus 30 are provided, respectively. Between the first gate 31 and the second gate 32 and in the vicinity of the first gate 31, there is provided a second authentication zone A2 where the authentication of the target P2 is performed. When the first gate 31 of the second lane LA2 is opened, the target P2 moves from the second trigger zone TR2 to the second authentication zone A2. Thus, the authentication apparatus 10 switches between the image capturing directions of the iris camera 108 to capture an image of the target P2 and captures an image of an iris of the target P2. While the biometric identification is executed on a target in one of the first lane LA1 and the second lane LA2, the authentication apparatus 10 controls the gate apparatus restricting movement to another one of the first lane LA1 and the second lane LA2 in a closed state. When the biometric identification is completed, the authentication apparatus 10 controls the gate apparatus 30 in an opened state. In this case, it is possible to avoid the passage of an unauthenticated target.

Thus, the authentication system 1 individually authenticates the target P1 who is moving in the first lane in LA1 the first direction D1 toward the authentication apparatus 10 and the target P2 who is moving in the second lane LA2 in the second direction D2 toward the authentication apparatus 10.

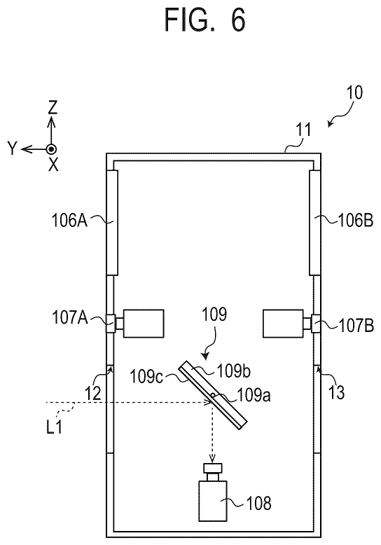

FIG. 6 to FIG. 9 are diagrams for describing the internal structure of the authentication apparatus 10 according to the first example embodiment. As illustrated in FIG. 6 to FIG. 9, the iris camera 108 is disposed with its lens surface oriented in a vertically upward direction (the positive direction of the Z-axis) and faces the rotating mirror 109 positioned above. The rotating mirror 109 includes a rotation axis 109a, a support substrate 109b, and a mirror surface 109c.

A dashed arrow L1 in FIG. 6 indicates a traveling direction of light entering through the first opening 12 on the front surface side of the housing 11. Light L1 is reflected off the mirror surface 109c of the rotating mirror 109 and then enters the iris camera 108. In FIG. 6, the light L1 enters horizontally from the front surface side of the housing 11. For this reason, the image capturing direction of the iris camera 108 is 0 degrees to a horizontal plane. In the first example embodiment, a set mode in which the rotating mirror 109 is set at an inclination angle illustrated in FIG. 6 is called a first preparation mode. In a first authentication mode described later, the inclination angle of the rotating mirror 109 (a mirror angle) is set within a predetermined range spanning in an up-down direction across the inclination angle set in the first preparation mode.

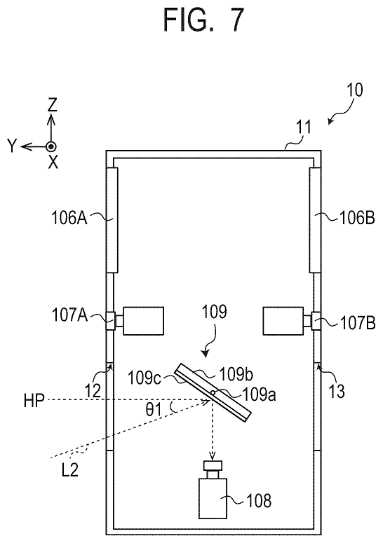

In contrast, in FIG. 7, the rotating mirror 109 rotates counterclockwise from the state illustrated in FIG. 6. The rotating mirror 109 reflects light L2 entering obliquely from below a horizontal plane HP at an angle θ1, back toward the iris camera 108. In the first example embodiment, as illustrated in FIG. 7, a set mode in which the rotating mirror 109 is set at an inclination angle in alignment with an eye position of a target present on the front surface side of the housing 11 is called the first authentication mode. Note that, in the first authentication mode, the rotating mirror 109 may rotate clockwise from the state illustrated in FIG. 6 in accordance with the height of the target. The image capturing directions of the iris camera 108 can be changed by the driving of the rotating mirror 109 in the up-down direction with respect to the horizontal plane.

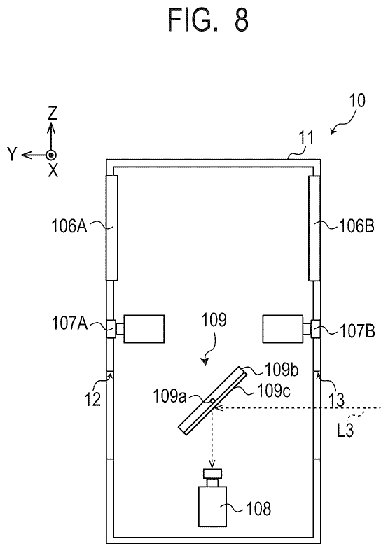

A dashed arrow L3 in FIG. 8 indicates a traveling direction of light entering through the second opening 13 on the back surface side of the housing 11. Light L3 is reflected off the mirror surface 109c of the rotating mirror 109 and then enters the iris camera 108. In FIG. 8, the light L3 enters horizontally from the back surface side of the housing 11. With respect to the state of FIG. 6, the image capturing direction of the iris camera 108 is 180 degrees to the horizontal plane. In the first example embodiment, a set mode in which the rotating mirror 109 is set at an inclination angle illustrated in FIG. 8 is called a second preparation mode. In a second authentication mode described later, the inclination angle of the rotating mirror 109 (the mirror angle) in capturing an image is set within a predetermined range spanning in the up-down direction across the inclination angle set in the second preparation mode.

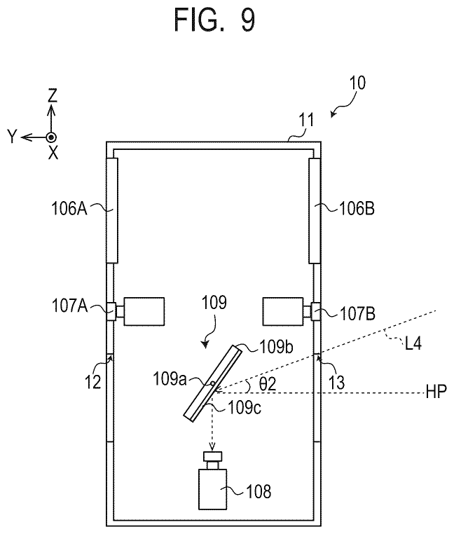

In contrast, in FIG. 9, the rotating mirror 109 rotates counterclockwise from the state illustrated in FIG. 8. The rotating mirror 109 reflects light L2 entering obliquely from above the horizontal plane HP at an angle θ2, back toward the iris camera 108. In the first example embodiment, as illustrated in FIG. 7, a set mode in which the rotating mirror 109 is set at an inclination angle in alignment with an eye position of a target present on the front surface side of the housing 11 is called the second authentication mode. Note that, in the second authentication mode, the rotating mirror 109 may rotate clockwise from the state illustrated in FIG. 8 in accordance with the height of the target.

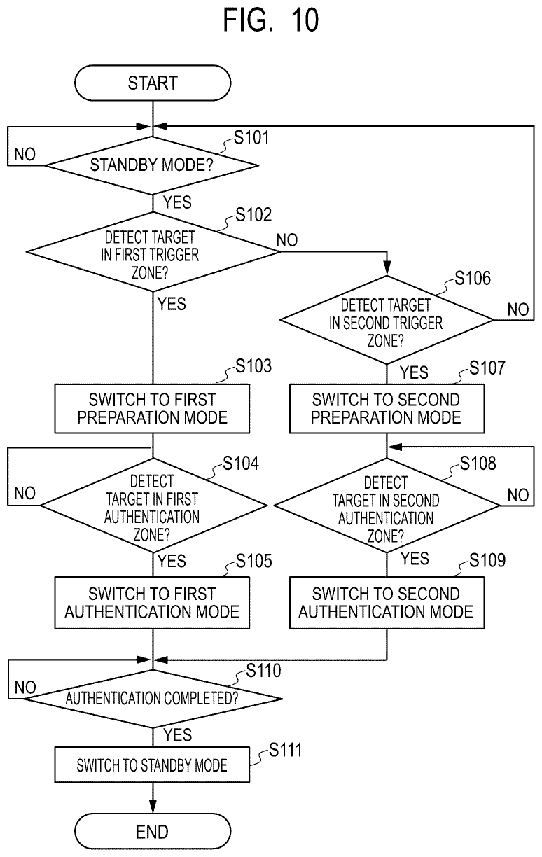

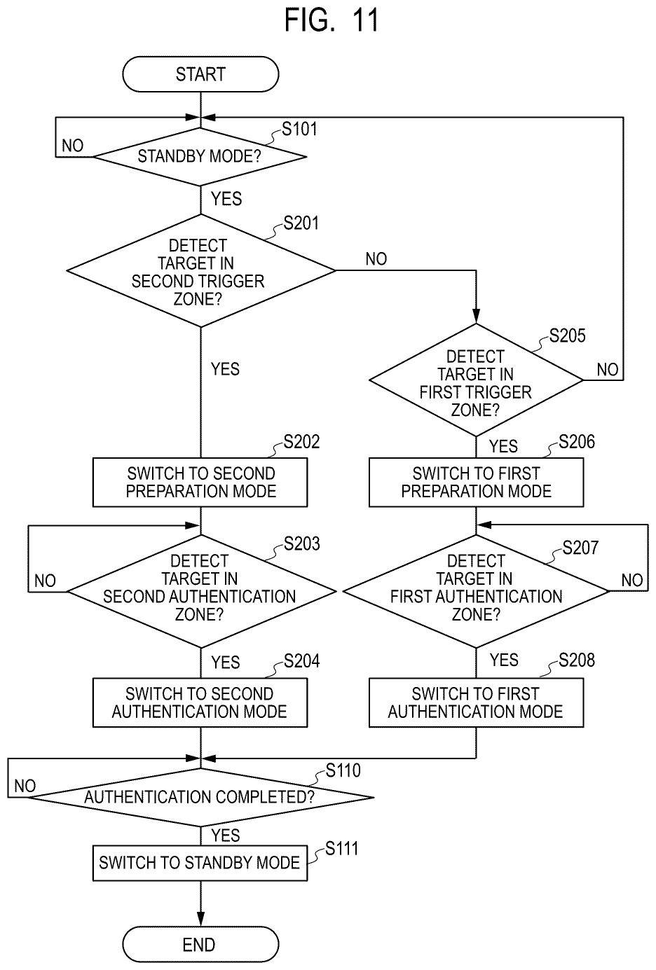

FIG. 10 is a flowchart illustrating an outline of processing executed by the authentication apparatus 10 according to the first example embodiment. The processing in FIG. 10 is processing for switching set modes of the authentication apparatus 10. The set modes in the first example embodiment include five modes: a standby mode, the first preparation mode, the first authentication mode, the second preparation mode, and the second authentication mode. The standby mode is a set mode in an initial state.

In step S101, the authentication apparatus 10 determines whether a current set mode is the standby mode.

Here, if the authentication apparatus 10 determines that the set mode is the standby mode (step S101: YES), the processing proceeds to step S102. On the other hand, if the authentication apparatus 10 determines that the set mode is not the standby mode (step S101: NO), the processing of step S101 is repeated until the set mode becomes the standby mode. For example, the set mode is determined to be other than the standby mode when the preparation mode or one of the authentication modes is set for another target. In this case, the processing of step S101 is repeated until the authentication performed on the other target is completed, and the set mode is reset to the standby mode.

In step S102, the authentication apparatus 10 determines whether a target has been detected in the first trigger zone TR1 of the first lane LA1 on the basis of a detection signal from a proximity sensor 40.

Here, if the authentication apparatus 10 determines that a target has been detected in the first trigger zone TR1 of the first lane LA1 (step S102: YES), the set mode is switched to the first preparation mode (step S103), and the processing proceeds to step S104.

On the other hand, if the authentication apparatus 10 determines that no target has been detected in the first trigger zone TR1 of the first lane LA1 (step S102: NO), the processing proceeds to step S106.

In step S104, the authentication apparatus 10 determines whether the target has been detected in the first authentication zone A1 on the basis of a detection signal from a proximity sensor 40. That is, it is determined whether the target has moved from the first trigger zone TR1 to the first authentication zone A1 in the first lane LA1.

Here, if the authentication apparatus 10 determines that the target has been detected in the first authentication zone A1 of the first lane LA1 (step S104: YES), the set mode is switched to the first authentication mode (step S105), and the processing proceeds to step S110. On the other hand, if the authentication apparatus 10 determines that the target has not been detected in the first authentication zone A1 (step S104: NO), the processing of step S104 is repeated.

In step S106, the authentication apparatus 10 determines whether a target has been detected in the second trigger zone TR2 of the second lane LA2 on the basis of a detection signal from a proximity sensor 40.

Here, if the authentication apparatus 10 determines that a target has been detected in the second trigger zone TR2 of the second lane LA2 (step S106: YES), the set mode is switched to the second preparation mode (step S107), and the processing proceeds to step S108.

On the other hand, if the authentication apparatus 10 determines that no target has been detected in the second trigger zone TR2 of the second lane LA2 (step S106: NO), the processing returns to step S101.

In step S108, the authentication apparatus 10 determines whether the target has been detected in the second authentication zone A2 of the second lane LA2 on the basis of a detection signal from a proximity sensor 40. That is, it is determined whether the target has moved from the second trigger zone TR2 to the second authentication zone A2 in the second lane LA2.

Here, if the authentication apparatus 10 determines that the target has been detected in the second authentication zone A2 of the second lane LA2 (step S108: YES), the set mode is switched to the second authentication mode (step S109), and the processing proceeds to step S110. On the other hand, if the authentication apparatus 10 determines that the target has not been detected in the second authentication zone A2 (step S108: NO), the processing of step S108 is repeated.

In step S110, the authentication apparatus 10 determines whether the biometric identification performed on the target has been completed. Here, if the authentication apparatus 10 determines that the biometric identification has been completed (step S110: YES), the set mode is switched to the standby mode (step S111), and the processing is finished.

On the other hand, if the authentication apparatus 10 determines that the biometric identification has not been completed (step S110: NO), the processing of step S110 is repeated until the biometric identification is completed.

As seen from the above, in the processing in FIG. 10, since the presence or absence of a target in the first trigger zone TR1 of the first lane LA1 is determined earlier than the presence or absence of a target in the second trigger zone TR2 of the second lane LA2, the biometric identification can be executed preferentially in the first lane LA1 over the second lane LA2. In addition, exclusive control is performed such that the set mode cannot be switched to the preparation mode or the authentication mode in one lane until the biometric identification is completed in the other lane.

FIG. 11 is a flowchart illustrating an outline of processing executed by the authentication apparatus 10 according to the first example embodiment. The processing in FIG. 11 differs from that in FIG. 10 in steps S201 to S208. Processing different from that in FIG. 10 will be described below.

After step S101, the processing proceeds to step S201. In step S201, the authentication apparatus 10 determines whether a target has been detected in the second trigger zone TR2 of the second lane LA2 on the basis of a detection signal from the proximity sensor 40.

Here, if the authentication apparatus 10 determines that a target has been detected in the second trigger zone TR2 of the second lane LA2 (step S201: YES), the set mode is switched to the second preparation mode (step S202), and the processing proceeds to step S203.

On the other hand, if the authentication apparatus 10 determines that no target has been detected in the second trigger zone TR2 of the second lane LA2 (step S201: NO), the processing proceeds to step S205.

In step S203, the authentication apparatus 10 determines whether the target has been detected in the second authentication zone A2 of the second lane LA2 on the basis of a detection signal from the proximity sensor 40. That is, it is determined whether the target has moved from the second trigger zone TR2 to the second authentication zone A2 in the second lane LA2.

Here, if the authentication apparatus 10 determines that the target has been detected in the second authentication zone A2 of the second lane LA2 (step S203: YES), the set mode is switched to the second authentication mode (step S204), and the processing proceeds to step S110. On the other hand, if the authentication apparatus 10 determines that the target has not been detected in the second authentication zone A2 (step S203: NO), the processing of step S203 is repeated.

In step S205, the authentication apparatus 10 determines whether a target has been detected in the first trigger zone TR1 of the first lane LA1 on the basis of a detection signal from a proximity sensor 40.

Here, if the authentication apparatus 10 determines that a target has been detected in the first trigger zone TR1 of the first lane LA1 (step S205: YES), the set mode is switched to the first preparation mode (step S206), and the processing proceeds to step S207.

On the other hand, if the authentication apparatus 10 determines that no target has been detected in the first trigger zone TR1 of the first lane LA1 (step S205: NO), the processing returns to step S101.

In step S207, the authentication apparatus 10 determines whether the target has been detected in the first authentication zone A1 of the first lane LA1 on the basis of a detection signal from the proximity sensor 40. That is, it is determined whether the target has moved from the first trigger zone TR1 to the first authentication zone A1 in the first lane LA1.

Here, if the authentication apparatus 10 determines that the target has been detected in the first authentication zone A1 of the first lane LA1 (step S207: YES), the set mode is switched to the first authentication mode (step S208), and the processing proceeds to step S110. On the other hand, if the authentication apparatus 10 determines that the target has not been detected in the first authentication zone A1 of the first lane LA1 (step S207: NO), the processing of step S207 is repeated.

As seen from the above, in the processing in FIG. 11, unlike the case in FIG. 10, since the presence or absence of a target in the second trigger zone TR2 of the second lane LA2 is determined earlier than the presence or absence of a target in the first trigger zone TR1 of the first lane LA1, the biometric identification can be executed preferentially in the second lane LA2 over the first lane LA1.

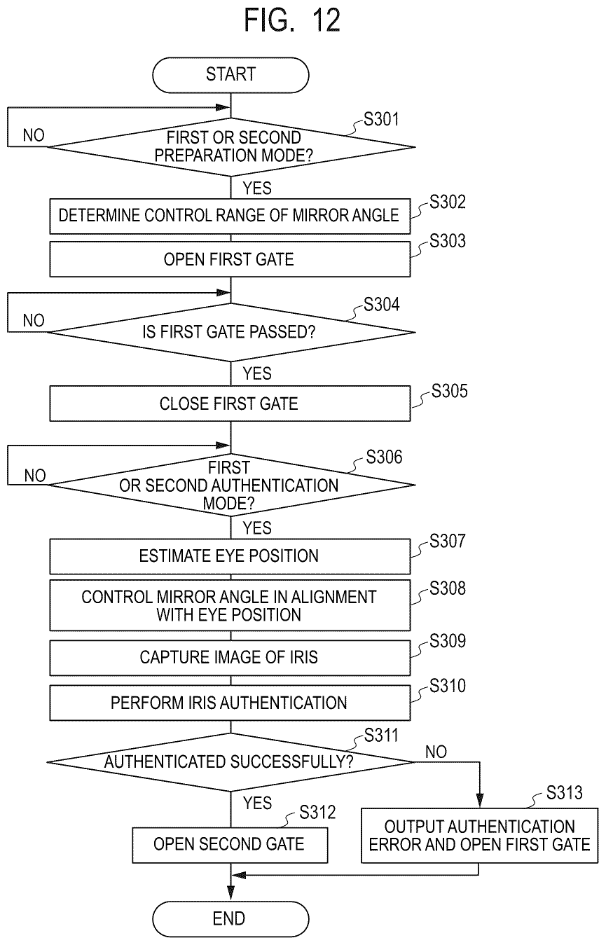

FIG. 12 is a flowchart illustrating an outline of processing executed by the authentication apparatus 10 according to the first example embodiment. The processing in FIG. 12 is executed independently of the processing in FIG. 10 and FIG. 11.

In step S301, the authentication apparatus 10 determines whether the current set mode is one of the preparation modes (the first preparation mode or the second preparation mode).

Here, if the authentication apparatus 10 determines that the set mode is the first or second preparation mode (step S301: YES), the processing proceeds to step S302. On the other hand, if the authentication apparatus 10 determines that the set mode is neither the first nor the second preparation mode (step S301: NO), the processing of step S301 is repeated until the set mode is changed to the first or second preparation mode.

In step S302, the authentication apparatus 10 determines the control range of the mirror angle in the first or second preparation mode. For example, in the first preparation mode, the authentication apparatus 10 drives the rotating mirror 109 such that the mirror surface 109c of the rotating mirror 109 faces the first authentication zone A1 of the first lane LA1. Likewise, in the second preparation mode, the authentication apparatus 10 drives the rotating mirror 109 such that the mirror surface 109c of the rotating mirror 109 faces the second authentication zone A2 of the second lane LA2. Thus, it is possible to minimize the amount of adjustment of the mirror angle in the case where the set mode is switched from the first preparation mode to the first authentication mode.

In step S303, the authentication apparatus 10 outputs, to the gate apparatus 30, a control signal to instruct the gate apparatus 30 to open a first gate 31. On the basis of the control signal from the authentication apparatus 10, the gate apparatus 30 opens the first gate. At this time, it is preferable that the authentication apparatus 10 display guidance information such as “Please move forward to complete authentication.” on the display 106. The provision of appropriate guidance information to a target can improve the efficiency of the biometric identification in the lane.

In step S304, the authentication apparatus 10 determines whether a target has passed through the first gate 31 on the basis of a detection signal from a proximity sensor 40. That is, the authentication apparatus 10 determines whether the target has moved from a trigger zone to an authentication zone.

Here, if the authentication apparatus 10 determines that the target has passed through the first gate 31 (step S304: YES), the authentication apparatus 10 outputs, to the gate apparatus 30, a control signal to instruct the gate apparatus 30 to close the first gate 31, and the processing proceeds to step S306. On the basis of the control signal from the authentication apparatus 10, the gate apparatus 30 closes the first gate 31.

In step S306, the authentication apparatus 10 determines whether the current set mode is the first or second authentication mode. Here, if the authentication apparatus 10 determines that the set mode is the first or second authentication mode (step S306: YES), the processing proceeds to step S307.

On the other hand, if the authentication apparatus 10 determines that the set mode is neither the first authentication mode nor the second authentication mode (step S306: NO), the processing of step 306 is repeated until the set mode is changed to the first or second authentication mode.

In step S307, the authentication apparatus 10 analyzes an image of the target in the authentication zone captured by the first general-view camera 107A or the second general-view camera 107B to estimate an eye position of the target. The eye position of the target means the height position of an eye in a vertical direction. The eye position can be estimated based on, for example, the distance from the installation position of the authentication apparatus 10 to a zone where the target is present and the distance in a coordinate system from a foot to the eye of the target in the image.

In step S308, the authentication apparatus 10 controls the mirror angle (tilt angle) of the rotating mirror 109 in alignment with the eye position estimated in step S307.

In step S309, the authentication apparatus 10 captures an image of an iris of the target with the iris camera 108 to generate an iris image.

In step S310, on the basis of the iris image, the authentication apparatus 10 requests the authentication server 20 to execute the iris authentication. The authentication server 20 executes the iris authentication by checking the iris image received from the authentication apparatus 10 against registered iris images of registered persons stored in the database 22. The authentication server 20 then transmits the authentication result of the iris authentication to the authentication apparatus 10.

In step S311, receiving the authentication result from the authentication server 20, the authentication apparatus 10 determines whether the authentication of the target has succeeded.

Here, if the authentication apparatus 10 determines that the authentication has succeeded (step S311: YES), the authentication apparatus 10 outputs, to the gate apparatus 30, a control signal to instruct the gate apparatus 30 to open a second gate 32, and the processing is finished. At this time, it is preferable that the authentication apparatus 10 display guidance information such as “You have been successfully authenticated.” on the display 106.

On the other hand, if the authentication apparatus 10 determines that the authentication has failed (step S311: NO), the processing proceeds to step S313.

In step S313, the authentication apparatus 10 displays a message of an authentication error on the display 106 (the first display 106A or the second display 106B) that faces the target of whom the authentication has failed and outputs, to the gate apparatus 30, a control information to instruct the gate apparatus 30 to open the first gate, and the processing is finished. At this time, it is preferable that the authentication apparatus 10 display guidance information such as “Authentication has failed.” on the display 106.

In general, in a gate system provided with a plurality of lanes through which targets pass to enter or exit from a managed area, it is often the case that optical equipment for capturing an image of a target is disposed in each of the lanes. However, the provision of the optical equipment for each lane disadvantageously increases initial costs. In contrast, with the authentication system 1 according to the first example embodiment, one authentication apparatus can execute the biometric identification on a plurality of targets who are approaching in a plurality of lanes in different directions. Thus, it is possible to reduce the initial costs of the authentication system 1.

While the rotating mirror 109 is in rotating operation, image capturing with the iris camera 108 is not performed, and the image capturing is performed at the timing when the rotating operation is completed. Thus, it is possible to avoid unnecessary image capturing and reduce operational costs. In addition, while the rotating mirror 109 is in the rotating operation, the iris camera 108 may be shaken, and a resulting captured image may be blurred. However, by causing the iris camera 108 to capture an image after the rotating operation of the rotating mirror 109 is completed, it is possible to reduce the shake of the iris camera 108, thus increasing the quality of the captured image.

### Second Example Embodiment

An authentication system 1 according to a second example embodiment will be described below. The following describes mainly differences from the first example embodiment. The description of the points common to the first example embodiment will be omitted or simplified.

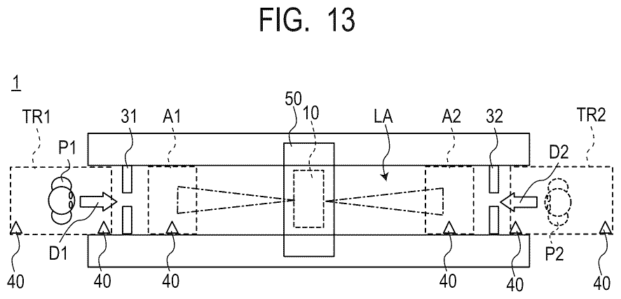

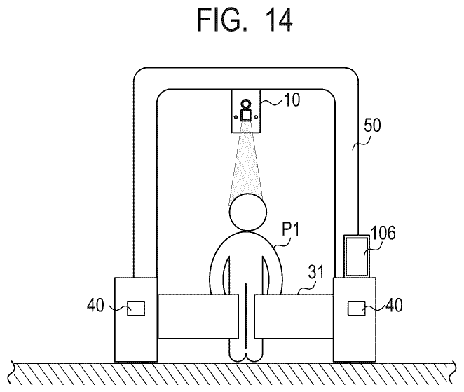

FIG. 13 is a top view for describing the general configuration of the authentication system 1 according to the second example embodiment. FIG. 14 is a front view for describing the general configuration of the authentication system 1 according to the second example embodiment. As illustrated in FIG. 13 and FIG. 14, in the second example embodiment, a first trigger zone TR1 is provided at one end of one lane LA, and a second trigger zone TR2 is provided at the other end.

In addition, between the first gate 31 and the second gate 32, an installation mount 50 in a U-shape is provided spanning the lane LA. As illustrated in FIG. 14, an authentication apparatus 10 of the second example embodiment is attached to the installation mount 50 and captures, obliquely downward, an image of a target P1 who is moving from the first trigger zone TR1 to a first authentication zone A1. The same holds true for the case of capturing an image of a target P2 who is moving from the second trigger zone TR2 to a second authentication zone A2.

When a proximity sensor 40 detects the target P1 moving in a direction D1, the authentication apparatus 10 drives a rotating mirror 109 to set an image capturing range to the first authentication zone A1. Conversely, when a proximity sensor 40 on the opposite side of the first lane LA1 detects the target P2 moving in a direction D2, the authentication apparatus 10 drives the rotating mirror 109 to switch the image capturing range from the first authentication zone A1 to the second authentication zone A2. Note that the installation location of the authentication apparatus 10 is not limited to the installation mount 50. In the case where the lane LA is installed indoors, the authentication apparatus 10 may be, for example, installed on a part of the ceiling directly above the lane LA.

As described above, with the authentication system 1 according to the second example embodiment, by switching the image capturing directions of one authentication apparatus 10 as appropriate, it is possible to sequentially execute the biometric identification on a plurality of targets who approach the authentication apparatus 10 in both directions in the same lane LA.

### Third Example Embodiment

An authentication system 1 according to a third example embodiment will be described below. The following describes mainly differences from the first example embodiment. The description of the points common to the first example embodiment will be omitted or simplified.

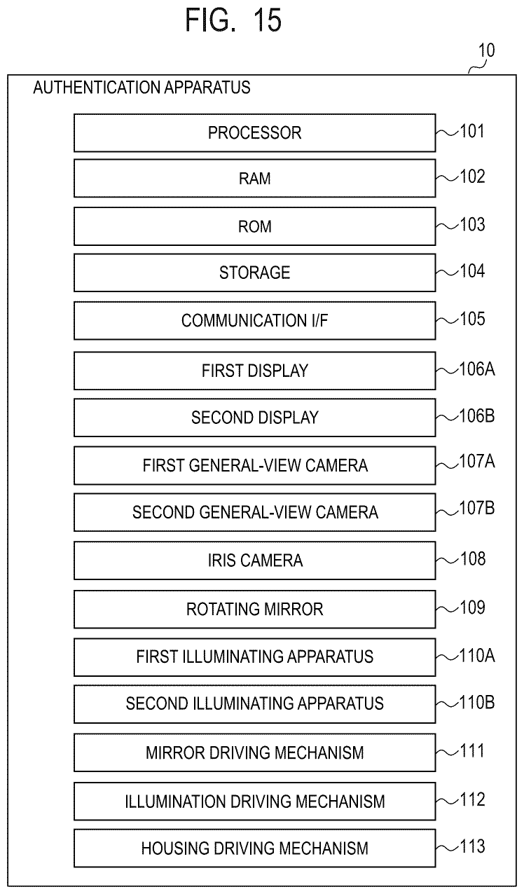

FIG. 15 is a block diagram illustrating an example of a hardware configuration of an authentication apparatus 10 according to the third example embodiment. The authentication apparatus 10 of the third example embodiment differs from the authentication apparatus 10 illustrated in FIG. 2 in further including a housing driving mechanism 113. The housing driving mechanism 113 rotationally drives a housing 11 that houses an image capturing unit (various cameras), an illuminating unit (various illuminating apparatuses), and a rotating mirror 109.

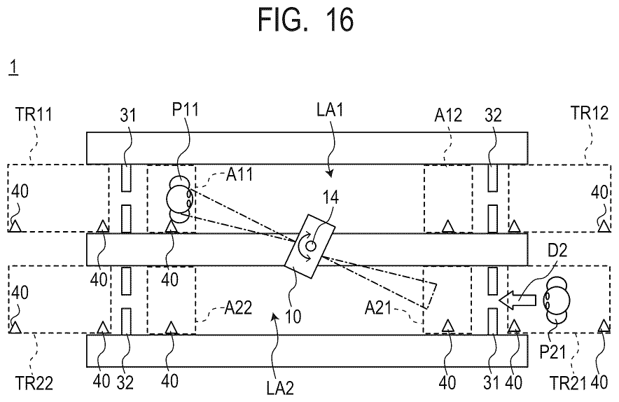

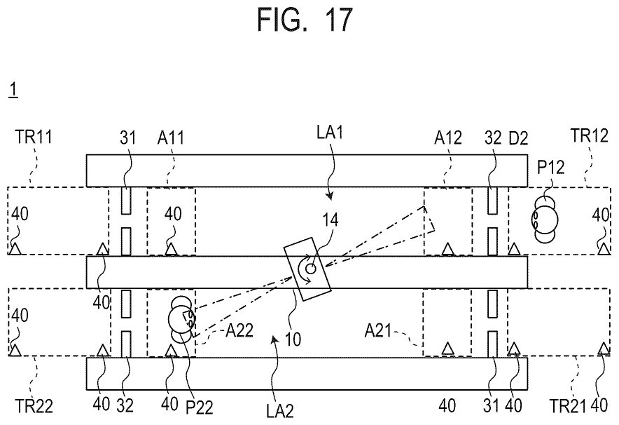

FIG. 16 and FIG. 17 are each a top view for describing the general configuration of the authentication system 1 according to the third example embodiment. FIG. 16 and FIG. 17 each illustrate a state where the authentication apparatus 10 is rotationally driven about a rotation axis 14 that extends perpendicularly to a horizontal plane. When targets P11 to P14 are detected in trigger zones, the authentication apparatus 10 can switch its image capturing ranges to one of authentication zones A11, A12, A21, and A22 by rotating about the rotation axis 14 and driving the rotating mirror 109 inside the authentication apparatus 10.

In the third example embodiment, as illustrated in FIG. 16 and FIG. 17, a first trigger zone TR11 is provided at one end of the first lane LA1, and a second trigger zone TR12 is provided at the other end. Between a first gate 31 and a second gate 32, a first authentication zone A11 and a second authentication zone A12 of the first lane LA1 are provided. The first authentication zone A11 is a region for authenticating the target P11 who has passed through the first gate 31 from the first trigger zone TR11. The second authentication zone A12 is a region for authenticating the target P12 who has passed through the second gate 32 from the second trigger zone TR12.

As with the first lane LA1, a first trigger zone TR21 is provided at one end of the second lane LA2, and a second trigger zone TR22 is provided at the other end. Between a first gate 31 and a second gate 32 of the second lane LA2, a first authentication zone A21 and a second authentication zone A22 of the second lane LA2 are provided. The first authentication zone A21 is a region for authenticating the target P21 who has passed through the first gate 31 from the first trigger zone TR21. The second authentication zone A22 is a region for authenticating the target P22 who has passed through the second gate 32 from the second trigger zone TR22.

As illustrated in FIG. 16, the authentication apparatus 10 can switch its image capturing range between the first authentication zone A11 of the first lane LA1 and the first authentication zone A21 of the second lane LA2 by being pan-driven about the rotation axis 14 and further driving the rotating mirror 109. Likewise, as illustrated in FIG. 17, the authentication apparatus 10 can switch its image capturing range between the second authentication zone A12 of the first lane LA1 and the second authentication zone A22 of the second lane LA2 by being pan-driven and further driving the rotating mirror 109.

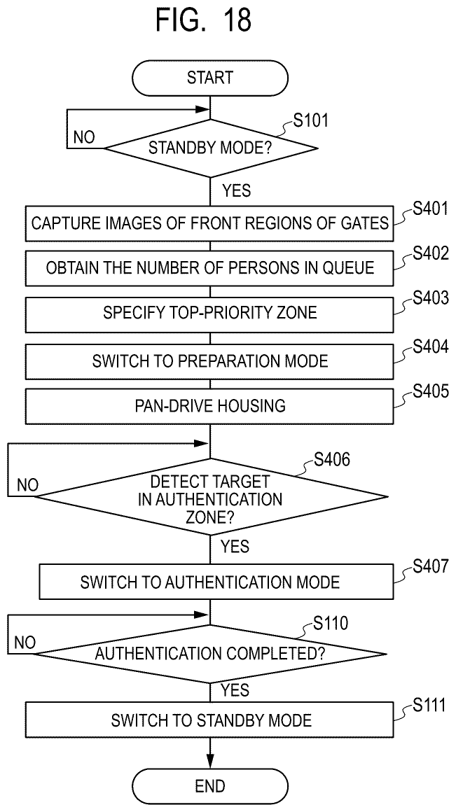

FIG. 18 is a flowchart illustrating an outline of processing executed by the authentication apparatus according to the third example embodiment. The processing in FIG. 18 differs from the processing in FIG. 10 in steps S401 to S407.

After step S101, the processing proceeds to step S401. In step S401, the authentication apparatus 10 captures images of front regions of the gates. In the example illustrated in FIG. 16 and FIG. 17, the authentication apparatus 10 captures images of regions outside four gates (two first gates 31 and two second gates 32).

In step S402, the authentication apparatus 10 analyzes the captured images to obtain the numbers of waiting persons in the respective regions. For example, in the case where the authentication apparatus 10 captures an image of the first trigger zone TR11 of the first lane LA1 and a region including a position in the rear of the first trigger zone TR11 and detects faces of five persons from the captured image, the number of persons in a queue is regarded as five.

In step S403, the authentication apparatus 10 specifies a top-priority zone from among all of the trigger zones. example, the authentication apparatus 10 specifies, as the top-priority zone, a zone including the largest number of waiting persons from among all of the trigger zones.

In step S404, the authentication apparatus 10 switches its set mode to a preparation mode corresponding to the top-priority trigger zone. For example, in the case where the first trigger zone TR11 is the top-priority zone among all of the trigger zones, the set mode is switched to the first preparation mode.

In step S405, the authentication apparatus 10 pan-drives its housing in accommodate with the preparation mode. Note that the direction of the pan-driving and the necessity of the driving can be determined with consideration given to the current position of the authentication apparatus 10 and the position of the authentication apparatus 10 after the driving.

For example, in the case where the image capturing range is switched from the first authentication zone A11 of the first lane LA1 to the first authentication zone A21 of the second lane LA2, it is only necessary to drive the rotating mirror 109, and thus the pan-drive need not be performed. In the case where the image capturing range is switched from the first authentication zone A11 of the first lane LA1 to the second authentication zone A22 of the second lane LA2, both the pan-driving and the driving of the rotating mirror 109 are performed. Thus, it is possible to minimize the amount of driving of the authentication apparatus 10.

In step S406, the authentication apparatus 10 determines whether a target has been detected in an authentication zone. Here, if the authentication apparatus 10 determines that a target has been detected in the authentication zone (step S406: YES), the set mode is switched to an authentication mode (step S407), and the processing proceeds to step S110.

For example, in the case where the target has been detected in an authentication zone of the first lane LA1, the authentication apparatus 10 switches the set mode from first the preparation to the first mode authentication mode. Likewise, in the case where the target has been detected in an authentication zone of the second lane LA2, the authentication apparatus 10 switches the set mode from the second preparation mode to the second authentication mode.

On the other hand, if the authentication apparatus 10 determines that no target has been detected in an authentication zone corresponding to the current preparation mode (step S406: NO), the processing of step S406 is repeated until a target is detected in the authentication zone. For example, in the case where the current preparation mode is the first preparation mode, whether a target has been detected in the first authentication zone All of the first lane LA1 is determined.

As described above, since the authentication system 1 according to the third example embodiment has the configuration in which the entire authentication apparatus 10 is rotationally driven about the rotation axis extending in the perpendicular direction, one authentication apparatus 10 can execute the biometric identification on targets who approach the authentication apparatus 10 in both directions in two adjacent lanes. Thus, it is possible to further reduce the initial costs of the authentication system 1.

### Fourth Example Embodiment

An authentication system 1 according to a fourth example embodiment will be described below. The following describes mainly differences from the first example embodiment. The description of the points common to the first example embodiment will be omitted or simplified.

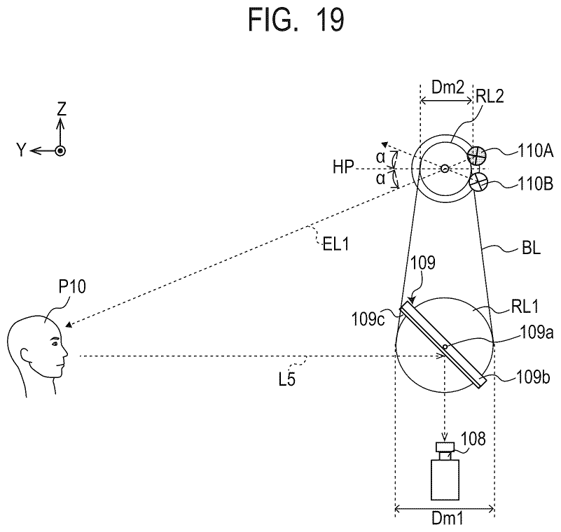

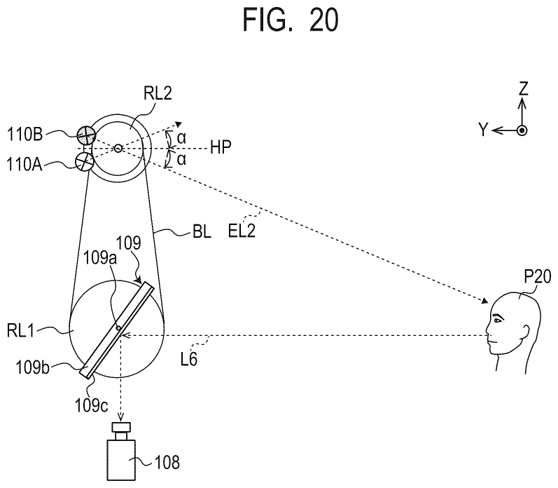

FIG. 19 and FIG. 20 are schematic diagrams for describing the internal structure of an authentication apparatus 10 according to the fourth example embodiment. A rotating mirror 109 is connected to a roller RL1. The roller RL1 is connected to a rotation axis 109a of the rotating mirror 109, and thus the roller RL1 and the rotating mirror 109 rotates together.

Above the rotating mirror 109, a roller RL2 is provided. The roller RL2 is connected to a first illuminating apparatus 110A and a second illuminating apparatus 110B. The fourth example embodiment differs from the first example embodiment in that the first illuminating apparatus 110A and the second illuminating apparatus 110B are driven together with the roller RL2.

A diameter Dm2 of the roller RL2 is half a diameter Dm1 of the roller RL1. On the circumferential surfaces of the roller RL1 and the roller RL2, an endless belt BL is wound. Thus, the rotating mirror 109, the first illuminating apparatus 110A, and the second illuminating apparatus 110B are driven together.

In addition, the first illuminating apparatus 110A and the second illuminating apparatus 110B are each set inclined at an inclination angle x with respect to a horizontal plane HP. The inclination angle a is set such that an application range of illumination light applied by the first illuminating apparatus 110A or the second illuminating apparatus 110B matches the image capturing range of an iris camera 108.

In FIG. 19, illumination light EL1 of the first illuminating apparatus 110A is applied to the face of a target P10. Light L5 that travels in a horizontal direction from a face part of the target P10 is reflected off a mirror surface 109c of the rotating mirror 109 and reaches the iris camera 108. In this state, the image capturing angle (view angle) of the iris camera 108 is assumed to be 0 degrees. This image capturing angle is set when the set mode is a first authentication mode. In the first authentication mode of the fourth example embodiment, only the first illuminating apparatus 110A applies the illumination light.

In contrast, in FIG. 19, illumination light EL20 of the second illuminating apparatus 110B is applied to the face of a target P20. Light L6 that travels in the horizontal direction from a face part of the target P20 is reflected off the mirror surface 109c of the rotating mirror 109 and reaches the iris camera 108. In this state, the image capturing angle (view angle) of the iris camera 108 is assumed to be 180 degrees. This image capturing angle is set when the set mode is a second authentication mode. In the second authentication mode of the fourth example embodiment, only the second illuminating apparatus 110B applies the illumination light.

When the iris camera 108 captures a mirror image reflected on the rotating mirror 109, the image capturing angle of the iris camera 108 varies twice as much as the rotation angle of the rotating mirror 109. As a result, when the image capturing angle of the iris camera 108 changes by an angle 0, the application angle of the illumination light generated by the first illuminating apparatus 110A and the second illuminating apparatus 110B also changes by the angle θ. For this reason, the diameter Dm2 of the roller RL2 is set to be half the diameter Dm1 of the roller RL1. The ratio of the rotation angle of the rotating mirror 109 and the rotation angle of each illuminating apparatus 110 is set to 1:2.

In the fourth example embodiment, the first illuminating apparatus 110A and the second illuminating apparatus 110B, which serve as light sources, are installed above the rotating mirror 109 and are therefore fixed to the roller RL2, inclined at the predetermined inclination angle a. In more detail, in the state where the image capturing direction is the horizontal direction, the application direction of the first illuminating apparatus 110A, which is a first light source, intersects the horizontal direction at a first inclination angle a. In the state where the image capturing direction is the horizontal direction, the application direction of the second illuminating apparatus 110B, which is a second light source, intersects the horizontal direction at a second inclination angle α. The first inclination angle α and the second inclination angle x are the same in size and are formed in opposite directions to each other from the horizontal direction. For this reason, even when the rotating mirror 109 is driven arbitrarily, the image capturing range of the iris camera 108 matches the application range of the illumination light generated by the first illuminating apparatus 110A or the second illuminating apparatus 110B.

Note that a linkage structure that enables the illumination unit to rotate in accordance with a change in the image capturing angle of the iris camera 108 is not limited to the structure including the roller RL1, the roller RL2, and the endless belt BL illustrated in FIG. 19 and FIG. 20. For example, the linkage structure may be a structure in which a plurality of gears are used as linking members instead of the endless belt BL.

As described above, with the authentication apparatus according to the fourth example embodiment, the first illuminating apparatus 110A and the second illuminating apparatus interlocked with the 110B rotation of the rotating mirror 109 enables the illumination light to be applied to a body part to be authenticated of a target with high accuracy.

### Fifth Example Embodiment

An authentication system 1 according to a fifth example embodiment will be described below. The following describes mainly differences from the first example embodiment. The description of the points common to the first example embodiment will be omitted or simplified.

The authentication system 1 according to the fifth example embodiment differs from that according to the first example embodiment in that the authentication system 1 according to the fifth example embodiment compares the numbers of persons in queues in a first lane LA1 and a second lane LA2 to determine a lane in which the biometric identification is to be executed on a target preferentially.

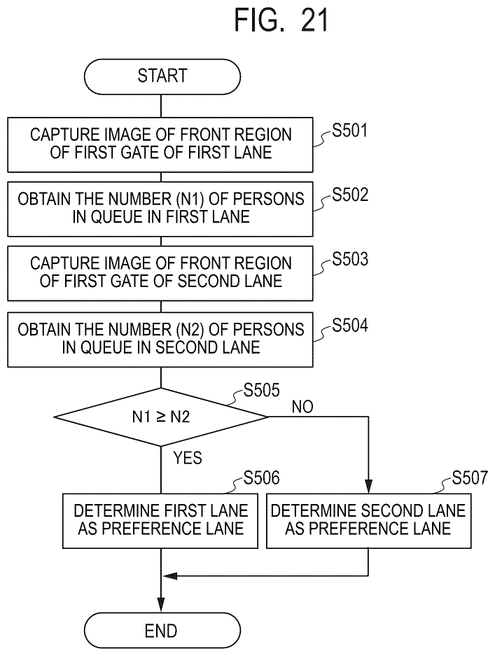

FIG. 21 is a flowchart illustrating an outline of processing executed by an authentication apparatus 10 according to the example fifth embodiment. The following description will be given based on the example of the first lane LA1 and the second lane LA2 illustrated in FIG. 5.

In step S501, the authentication apparatus 10 captures an image of a front region including the first trigger zone TR1 of the first lane LA1.

In step S502, the authentication apparatus 10 obtains a number N1 of persons in the queue in the first lane LA1.

In step S503, the authentication apparatus 10 captures an image of a front region including the second trigger zone of the second lane LA2.

In step S504, the authentication apparatus 10 obtains a number N2 of persons in the queue in the second lane LA2.

In step S505, the authentication apparatus 10 determines whether the number N1 of persons in the queue in the first lane is greater than or equal to the number N2 of persons in the queue in the second lane.

Here, if authentication apparatus 10 the determines that the number N1 of persons in the queue in the first lane LA1 is greater than or equal to the number N2 of persons in the queue in the second lane LA2 (step S505: YES), the processing proceeds to step S506.

On the other hand, if the authentication apparatus 10 determines that the number N1 of persons in the queue in the first lane is less than the number N2 of persons in the queue in the second lane LA2 (step S505: NO), the processing proceeds to step S507.

In step S506, the authentication apparatus 10 determines the first lane LA1 as a preference lane. At this time, the authentication apparatus 10 controls the rotation angle of the rotating mirror 109 such that the image capturing direction of the iris camera 108 is oriented toward the first lane LA1. In the case where the first lane LA1 is the preference lane, it is preferable to perform control such that the number of times the gate is opened in the first lane LA1 is greater than the number of times the gate is opened in the second lane LA2.

In step S507, the authentication apparatus 10 determines the second lane LA2 as the preference lane. At this time, the authentication apparatus 10 controls the rotation angle of the rotating mirror 109 such that the image capturing direction of the iris camera 108 is oriented toward the second lane LA2. In the case where the second lane LA2 is the preference lane, it is preferable to perform control such that the number of times the gate is opened in the second lane LA2 is greater than the number of times the gate is opened in the first lane LA1. Even when a target is detected in each of the trigger zones of the first lane LA1 and the second lane LA2, only a first gate 31 of the second lane LA2 on the entrance side of the second lane LA2 may be opened, with a first gate 31 of the first lane LA1 on the entrance side of the first gate 31 not opened.

As described above, with the authentication apparatus 10 according to the fifth example embodiment, it is possible to determine the degree of priority in the biometric identification with consideration given to the states of congestion in the first lane and the second lane and to switch the image capturing directions as appropriate on the basis of the degree of priority.

### Sixth Example Embodiment

An authentication system 1 according to a sixth example embodiment will be described below. The following describes mainly differences from the first example embodiment. The description of the points common to the first example embodiment will be omitted or simplified.

The authentication system 1 according to the sixth example embodiment differs from that according to the first example embodiment in that the authentication system 1 according to the sixth example embodiment determines a lane in which the biometric identification is to be executed preferentially, on the basis of the number of visitors in a managed area.

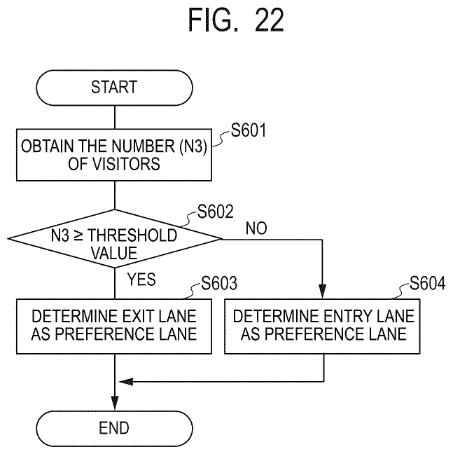

FIG. 22 is a flowchart illustrating an outline of processing executed by the authentication apparatus according to the sixth example embodiment. Note that FIG. 22 will be described on the assumption that the first lane is an entry lane, the second lane is an exit lane, and the lanes communicate with the managed area.

In step S601, an authentication apparatus 10 obtains a number N3 of visitors in the managed area from an authentication server 20.

In step S602, the authentication apparatus 10 determines whether the number N3 of visitors is greater than or equal to a predetermined threshold value. Here, if the authentication apparatus 10 determines that the number N3 of visitors is greater than or equal to the predetermined threshold value (step S602: YES), the processing proceeds to step S603.

On the other hand, if the authentication apparatus 10 determines that the number N3 of visitors is less than the predetermined threshold value (step S602: NO), the processing proceeds to step S604.

In step S603, the authentication apparatus 10 determines the exit lane as a preference lane and finishes the processing. In this case, the authentication apparatus 10 controls the rotation angle of a rotating mirror 109 such that the image capturing direction of an iris camera 108 is oriented toward the exit lane. When the exit lane is the preference lane, the authentication apparatus 10 may control the gate apparatus 30 in such a manner as to close the gate on the entry side and lane execute the biometric identification on only the exit lane side until the number of visitors decreases to less than the threshold value.

In step S604, the authentication apparatus 10 determines the entry lane as the preference lane and finishes the processing. In this case, the authentication apparatus 10 controls the rotation angle of the rotating mirror 109 such that the image capturing direction of the iris camera 108 is oriented toward the entry lane.

As described above, with the authentication apparatus 10 according to the sixth example embodiment, it is possible to determine the degree of priority in the biometric identification performed on the entry lane and the exit lane in accordance with the number of visitors in the managed area and to switch the image capturing directions as appropriate on the basis of the degree of priority.

### Seventh Example Embodiment

An authentication system 1 according to a seventh example embodiment will be described below. The following describes mainly differences from the first example embodiment. The description of the points common to the first example embodiment will be omitted or simplified.

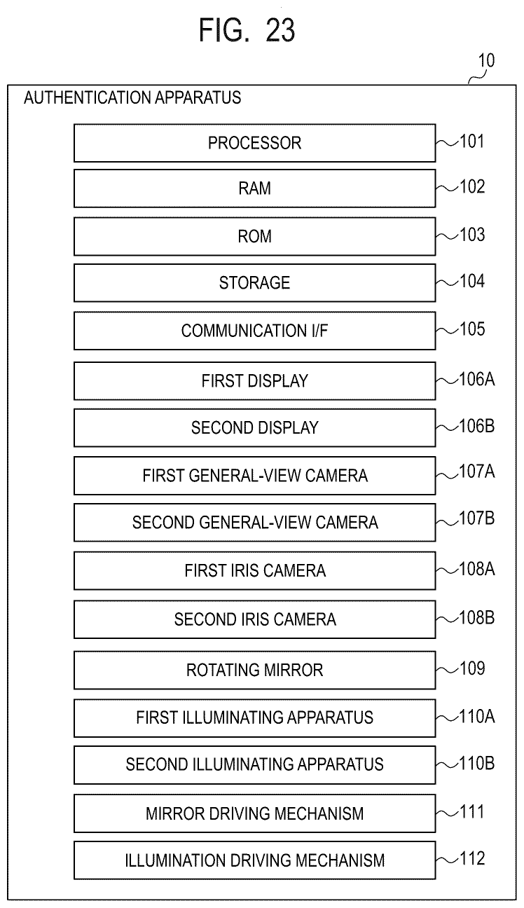

FIG. 23 is a block diagram illustrating an example of a hardware configuration of an authentication apparatus 10 according to the seventh example embodiment. The authentication apparatus 10 of the seventh example embodiment differs from the authentication apparatus 10 illustrated in FIG. 2 in including two iris cameras. A first iris camera 108A and a second iris camera 108B are equivalent in functionality to the iris camera 108 of the first example embodiment.

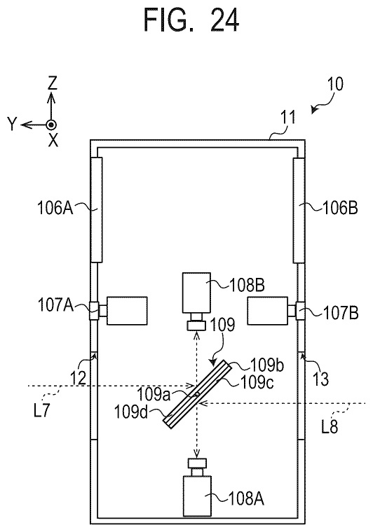

FIG. 24 is a schematic diagram for describing the internal structure of the authentication apparatus according to the seventh example embodiment. In FIG. 24, the first iris camera 108A is provided below a rotating mirror 109. The disposition of the first iris camera 108A is the same as that of the iris camera 108 of the first example embodiment.

Unlike the first example embodiment, the rotating mirror 109 of the seventh example embodiment is a double-sided mirror that includes a first mirror surface 109c and a second mirror surface 109d.

Above the rotating mirror 109, the second iris camera 108B is provided. The second iris camera 108B is disposed with its lens surface oriented in a vertically downward direction (the negative direction of the Z-axis) and faces the second mirror surface 109d of the rotating mirror 109 positioned below.

A dashed arrow L7 indicates a traveling direction of light entering through a first opening 12 on the front surface side of a housing 11. Light L7 is reflected off the second mirror surface 109d of the rotating mirror 109 and then enters the second iris camera 108B. In FIG. 24, the light L7 enters horizontally through the first opening 12. At this time, the image capturing direction of the second iris camera 108B is 0 degrees to a horizontal plane.

A dashed arrow L8 indicates a traveling direction of light entering through a second opening 13 on the back surface side of the housing 11. Light L8 is reflected off the mirror surface 109c of the rotating mirror 109 and then enters the first iris camera 108A. In FIG. 24, the light L8 enters horizontally through the second opening 13. At this time, the image capturing direction of the first iris camera 108A is 180 degrees to the horizontal plane, distinguished from the image capturing direction of the second iris camera 108B.

As described above, with the authentication apparatus according to the seventh example embodiment, the first iris camera 108A and the second iris camera 108B are disposed above and below the double-sided mirror, respectively, and it is thus possible to reduce the amount of driving of the rotating mirror 109 in switching the modes for the different lanes compared with the case of the first example embodiment. As a result, the time taken to switch the set mode can be shortened.

### Eighth Example Embodiment

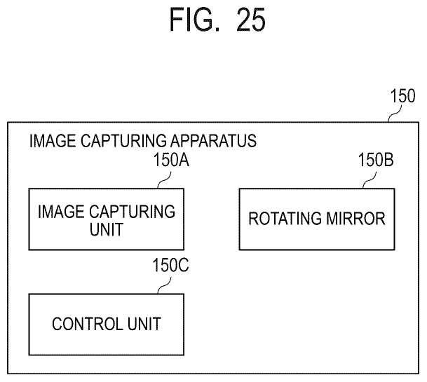

FIG. 25 is a functional block diagram illustrating the general configuration of an image capturing apparatus 150 according to an eighth example embodiment. The image capturing apparatus 150 includes an image capturing unit 150A, a rotating mirror 150B, and a control unit 150C. The image capturing unit A captures an image of a target. The rotating mirror 150B rotates about a first rotation axis and is capable of changing the image capturing direction of the image capturing unit. The control unit 150C controls the image capturing unit to capture an image of a target moving in a first direction in a first lane after causing the rotating mirror to rotate to a first angle and controls the image capturing unit to capture an image of a target moving in a second direction different from the first direction in a second lane after causing the rotating mirror to rotate to a second angle. According to the eighth example embodiment, there is provided the image capturing apparatus 150 that enables a low-cost implementation of the biometric identification performed on a plurality of targets approaching in both directions.

### Modified Example Embodiments

The present disclosure is not limited to the above-mentioned example embodiments and can be modified as appropriate without departing from the gist of the present disclosure. For example, an example in which a part of the configuration of some example embodiment is added to another example embodiment and an example in which a part of the configuration of some example embodiment is replaced with a part of the configuration of another example embodiment are also included in example embodiments of the present disclosure.

The above-mentioned first example embodiment describes the configuration in which the general-view cameras are provided on the front surface side and the back surface side of the authentication apparatus 10. However, the structure of the apparatus is not limited to this. For example, in the case where an omnidirectional camera, which can capture a 360-degree panoramic photograph and a 360-degree video in all directions including up, down, left, and right directions, is used as the general-view camera, only one such general-view camera may be provided in the authentication apparatus 10, and it is thus possible to reduce a production cost of the authentication apparatus 10.

The authentication apparatus 10 may further include a rotatable mirror for illumination that reflects the illumination light of the illuminating apparatus 110 toward a target. By interlocking the rotating mirror 109 with the mirror for illumination, it is possible to change the application direction of the illumination light of the illuminating apparatus 110 in alignment with the image capturing direction of the iris camera 108. In this case, only one illuminating apparatus 110 may be provided in the authentication apparatus 10, and it is thus possible to reduce the production cost of the authentication apparatus 10.

The above-mentioned fourth example embodiment describes the case where two illuminating apparatuses, the first illuminating apparatus 110A and the second illuminating apparatus 110B are attached as light sources to a single rotary member in the predetermined positional relationship. However, the first illuminating apparatus 110A and the second illuminating apparatus 110B may be independent of each other. Also in this case, the illuminating apparatus 110 (the illuminating unit) may include light sources each having an application direction that intersects the horizontal direction at a predetermined angle in the state where the image capturing direction is the horizontal direction. Thus, even when the rotating mirror 109 is driven arbitrarily, the image capturing range of the iris camera 108 matches the application range of the illumination light.

A processing method in which a program causing the configuration of any one of the above-mentioned example embodiments to operate so as to implement the functions of the example embodiment is recorded in a storage medium, the program recorded in the storage medium is read in the form of code, and a computer executes the code is also included in the scope of the example embodiment. That is, a computer-readable storage medium is also included in the scope of each example embodiment. Not only the storage medium in which the above-mentioned program is recorded but also the program itself is included in each example embodiment. One, or two or more constituent elements included the above-mentioned example embodiments may be a circuit such as an ASIC or an FPGA configured to implement the functions of the constituent elements.

As the storage medium, for example, a floppy (R) disk, a hard disk, an optical disk, a magneto-optical disk, a compact disk (CD)-ROM, a magnetic tape, a nonvolatile memory card, a ROM, or the like can be used. The scope of each example embodiment includes not only an apparatus or a system in which the processing is executed on the basis of only the program recorded in the storage medium but also an apparatus or a system in which the processing is executed on the basis of the program operating on an operating system (OS) in cooperation with other software and functions of an expansion board.

The service implemented with the functions of each above-mentioned example embodiment can also be provided to a user in the form of software as a service (Saas).

Note that any of the above-mentioned example embodiments is merely an example of an embodiment for carrying out the present disclosure, and the technical scope of the present disclosure should not be construed as being limited by the example embodiments. That is, the present disclosure can be carried out in various forms without departing from the technical idea or the main features thereof.

The whole or part of the above-mentioned example embodiments can be described as, but not limited to, the following supplementary notes.

### (Supplementary Note 1)

An image capturing apparatus comprising:
an image capturing unit that captures an image of a target;
a rotating mirror that rotates about a first rotation axis and is capable of changing an image capturing direction of the image capturing unit; and
a control unit that controls the image capturing unit to capture an image of the target moving in a first direction in a first lane after causing the rotating mirror to rotate to a first angle and controls the image capturing unit to capture an image of the target moving in a second direction in a second lane after causing the rotating mirror to rotate to a second angle, the second direction being different from the first direction.

### (Supplementary Note 2)

The image capturing apparatus according to supplementary note 1,
wherein the image capturing apparatus is located between the first lane and the second lane.

### (Supplementary Note 3)

The image capturing apparatus according to supplementary note 1 or 2,
wherein the apparatus as a whole rotates about a second rotation axis that extends in a perpendicular direction with respect to a horizontal plane.

### (Supplementary Note 4)

The image capturing apparatus according to any one of supplementary notes 1 to 3,
wherein if a number of first persons waiting in the first lane for image capturing by the image capturing unit is greater than or equal to a number of second persons waiting in the second lane for image capturing by the image capturing unit, the control unit controls the rotating mirror to rotate to the first angle, and if the number of first persons is less than the number of second persons, the control unit controls the rotating mirror to rotate to the second angle.

### (Supplementary Note 5)

The image capturing apparatus according to any one of supplementary notes 1 to 3,
wherein if a number of visitors in a managed area is less than a predetermined number, the control unit controls the rotating mirror to rotate to the first angle, and if the number of visitors is greater than or equal to the predetermined number, the control unit controls the rotating mirror to rotate to the second angle, the managed area communicating with the first lane and the second lane, the first lane being for entry, the second lane being for exit.

### (Supplementary Note 6)

The image capturing apparatus according to any one of supplementary notes 1 to 5,
wherein while biometric identification is executed on the target in one of the first lane and the second lane, the control unit controls a gate apparatus in a closed state, and when the biometric identification is completed, the control unit controls the gate apparatus in an opened state, the gate apparatus restricting movement to another one of the first lane and the second lane.

### (Supplementary Note 7)

The image capturing apparatus according to any one of supplementary notes 1 to 6, further comprising an illuminating unit that applies illumination light,
wherein the control unit changes an application direction of the illumination light of the illuminating unit in conjunction with a change in the image capturing direction.

### (Supplementary Note 8)

The image capturing apparatus according to supplementary note 7, further comprising a mirror for illumination, the mirror being configured to rotate about a third rotation axis and capable of changing the application direction,
wherein the control unit performs control such that a ratio of an angle by which the rotating mirror rotates and an angle by which the mirror for illumination rotates is 1:2.

### (Supplementary Note 9)

The image capturing apparatus according to supplementary Note 7, wherein the illuminating unit rotates about a fourth rotation axis that is parallel to the first rotation axis, and
the rotating mirror and the illuminating unit are connected together via a linking member such that a ratio of an angle by which the rotating mirror rotates and an angle by which the illuminating unit rotates is 1:2.

### (Supplementary Note 10)

The image capturing apparatus according to supplementary note 9,
wherein the illuminating unit includes a light source of which the application direction intersects a horizontal direction at a predetermined angle in a state where the image capturing direction is the horizontal direction.

### (Supplementary Note 11)

The image capturing apparatus according to supplementary note 9,
wherein the illuminating unit includes:
a first light source of which the application direction intersects a horizontal direction at a first inclination angle in a state where the image capturing direction is the horizontal direction; and
a second light source of which the application direction intersects the horizontal direction at a second inclination angle in the state where the image capturing direction is the horizontal direction, and the first inclination angle and the second inclination angle are the same in size and formed in opposite directions to each other from the horizontal direction.

### (Supplementary Note 12)

The image capturing apparatus according to any one of supplementary notes 1 to 11,
wherein while the rotating mirror is in a rotating operation, the control unit does not control the image capturing unit to capture an image of the target, and when the rotating operation is completed, the control unit controls the image capturing unit to capture an image of the target.

### (Supplementary Note 13)

The image capturing apparatus according to any one of supplementary notes 1 to 12,
wherein the control unit outputs guidance information about biometric identification to the target in each of the first lane and the second lane.

### (Supplementary Note 14)

The image capturing apparatus according to any one of supplementary notes 1 to 13,
wherein the rotating mirror includes a first mirror surface and a second mirror surface that faces the first mirror surface, and
wherein the image capturing unit includes a first camera and a second camera, the first camera capturing, via the first mirror surface, an image of the target present in the first lane, the second camera capturing, via the second mirror surface, an image of the target present in the second lane.

### (Supplementary Note 15)

An image capturing method comprising:
causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and
causing the image capturing unit to capture an image of the target moving in a second direction in a second lane after causing the rotating mirror to rotate to a second angle, the second direction being different from the first direction.

### (Supplementary Note 16)

A recording medium in which a program is recorded, the program causing a computer to execute:
causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and
causing the image capturing unit to capture an image of the target moving in a second direction in a second lane after causing the rotating mirror to rotate to a second angle, the second direction being different from the first direction.

### (Supplementary Note 17)

An image capturing apparatus comprising:
an image capturing unit that captures an image of a target;
a rotating mirror that rotates about a rotation axis and is capable of changing an image capturing direction of the image capturing unit; and
a control unit that controls the image capturing unit to capture an image of the target moving in a first direction in a lane after causing the rotating mirror to rotate to a first angle and controls the image capturing unit to capture an image of the target moving in a second direction in the lane after causing the rotating mirror to rotate to a second angle, the second direction being opposite to the first direction.

### REFERENCE SIGNS LIST

1 authentication system
10 authentication apparatus
20 authentication server
21 authentication engine
22 database
30 gate apparatus
31 first gate
32 second gate
40 proximity sensor
101 processor
102 RAM
103 ROM
104 storage
105 communication I/F
106 display
107 general-view camera
107A first general-view camera
107B second general-view camera
108 iris camera
108A first iris camera
108B second iris camera
109 rotating mirror
110 illuminating apparatus
110A first illuminating apparatus
110B second illuminating apparatus
111 mirror driving mechanism
112 illumination driving mechanism
113 housing driving mechanism
150 image capturing apparatus
150A rotating mirror
150B image capturing unit
150C control unit

What is claimed is:

1. An image capturing apparatus comprising:
an image capturing unit that captures an image of a target;
a rotating mirror that rotates about a first rotation axis and is capable of changing an image capturing direction of the image capturing unit; and
a control unit that controls the image capturing unit to capture an image of the target moving in a first direction in a first lane after causing the rotating mirror to rotate to a first angle and controls the image capturing unit to capture an image of the target moving in a second direction in a second lane after causing the rotating mirror to rotate to a second angle, the second direction being different from the first direction.

2. The image capturing apparatus according to claim 1,
wherein the image capturing apparatus is located between the first lane and the second lane.

3. The image capturing apparatus according to claim 1,
wherein the apparatus as a whole rotates about a second rotation axis that extends in a perpendicular direction with respect to a horizontal plane.

4. The image capturing apparatus according to claim 1,
wherein if a number of first persons waiting in the first lane for image capturing by the image capturing unit is greater than or equal to a number of second persons waiting in the second lane for image capturing by the image capturing unit, the control unit controls the rotating mirror to rotate to the first angle, and if the number of first persons is less than the number of second persons, the control unit controls the rotating mirror to rotate to the second angle.

5. The image capturing apparatus according to claim 1,
wherein if a number of visitors in a managed area is less than a predetermined number, the control unit controls the rotating mirror to rotate to the first angle, and if the number of visitors is greater than or equal to the predetermined number, the control unit controls the rotating mirror to rotate to the second angle, the managed area communicating with the first lane and the second lane, the first lane being for entry, the second lane being for exit.

6. The image capturing apparatus according to claim 1,
wherein while biometric identification is executed on the target in one of the first lane and the second lane, the control unit controls a gate apparatus in a closed state, and when the biometric identification is completed, the control unit controls the gate apparatus in an opened state, the gate apparatus restricting movement to another one of the first lane and the second lane.

7. The image capturing apparatus according to claim 1, further comprising an illuminating unit that applies illumination light, wherein the control unit changes an application direction of the illumination light of the illuminating unit in conjunction with a change in the image capturing direction.

8. The image capturing apparatus according to claim 7, further comprising a mirror for illumination, the mirror being configured to rotate about a third rotation axis and capable of changing the application direction,
wherein the control unit performs control such that a ratio of an angle by which the rotating mirror rotates and an angle by which the mirror for illumination rotates is 1:2.

9. The image capturing apparatus according to claim 7,
wherein the illuminating unit rotates about a fourth rotation axis that is parallel to the first rotation axis, and
the rotating mirror and the illuminating unit are connected together via a linking member such that a ratio of an angle by which the rotating mirror rotates and an angle by which the illuminating unit rotates is 1:2.

10. The image capturing apparatus according to claim 9,
wherein the illuminating unit includes a light source of which the application direction intersects a horizontal direction at a predetermined angle in a state where the image capturing direction is the horizontal direction.

11. The image capturing apparatus according to claim 9,
wherein the illuminating unit includes:
a first light source of which the application direction intersects a horizontal direction at a first inclination angle in a state where the image capturing direction is the horizontal direction; and
a second light source of which the application direction intersects the horizontal direction at a second inclination angle in the state where the image capturing direction is the horizontal direction, and
the first inclination angle and the second inclination angle are the same in size and formed in opposite directions to each other from the horizontal direction.

12. The image capturing apparatus according to claim 1
wherein while the rotating mirror is in a rotating operation, the control unit does not control the image capturing unit to capture an image of the target, and when the rotating operation is completed, the control unit controls the image capturing unit to capture an image of the target.

13. The image capturing apparatus according to claim 1,
wherein the control unit outputs guidance information about biometric identification to the target in each of the first lane and the second lane.

14. The image capturing apparatus according to claim 1,
wherein the rotating mirror includes a first mirror surface and a second mirror surface that faces the first mirror surface, and
wherein the image capturing unit includes a first camera and a second camera, the first camera capturing, via the first mirror surface, an image of the target present in the first lane, the second camera capturing, via the second mirror surface, an image of the target present in the second lane.

15. An image capturing method comprising:
causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and
causing the image capturing unit to capture an image of the target moving in a second direction in a second lane after causing the rotating mirror to rotate to a second angle, the second direction being different from the first direction.

16. A recording medium in which a program is recorded, the program causing a computer to execute:
causing an image capturing unit to capture an image of a target moving in a first direction in a first lane after causing a rotating mirror to rotate to a first angle, the rotating mirror rotating about a rotation axis and being capable of changing an image capturing direction of the image capturing unit; and
causing the image capturing unit to capture an image of the target moving in a second direction in a second lane after causing the rotating mirror to rotate to a second angle, the second direction being different from the first direction.

17. (canceled)
